(19) United States
(12) Patent Application Publication
(10) Pub. No.: US 2008/0024675 A1
(43) Pub. Date: Jan. 31, 2008

(54) Image correction circuit, image correction method and image display

(75) Inventors: Tomoyoshi Sekiguchi, Tokyo (JP); Yutaka Miki, Chiba (JP); Tatsumasa Kondo, Kanagawa (JP); Masatoshi Yamazaki, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/879,735

(22) Filed: Jul. 18, 2007

(30) Foreign Application Priority Data
Jul. 19, 2006 (JP) P2006-196534

(51) Int. Cl. H04N 5/14

(52) U.S. Cl. 348/700; 348/E05.065

(57) ABSTRACT

An image correction circuit capable of performing more effective image correction on an input image is provided. An image correction circuit may include a correction means for performing image correction on input image data; a detection means for detecting a degree of motion picture in the input image data; and a control means for controlling the degree of image correction by the correction means on the basis of the degree of motion picture detected by the detection means.

### CROSS-REFERENCE TO RELATED APPLICATIONS

This application claims priority from Japanese Patent Application No. JP 2006-196534 filed in the Japanese Patent Office on Jul. 19, 2006, the entire content of which is incorporated herein by reference.

### BACKGROUND OF THE INVENTION

1. Field of the Invention

The present invention relates to an image correction circuit having a function of performing a correction process on an image signal, an image correction method and an image display.

2. Description of the Related Art

Apparatuses such as television receivers (TVs), VCRs (Video Cassette Recorders), digital cameras, television cameras or printers typically have an image correction function which performs image correction on input image data, and then outputs the input image data (for example, luminance correction functions such as luminance or contrast control, and edge enhancement correction). Such image correction on input image data is effectively applied mainly to a totally dark and low-contrast image or a blurred image.

Moreover, input image data includes a still picture and a motion picture, so in related arts, image correction is performed in consideration of kinds of images. For example, in Japanese Unexamined Patent Application Publication No. 2003-319203, a noise reduction circuit for TV using a detection result by a motion detection circuit is proposed.

### SUMMARY OF THE INVENTION

In Japanese Unexamined Patent Application Publication No. 2003-319203, a motion detection circuit determines whether an image is a still picture or a motion picture, and a three-dimensional Y/C separation process is performed on the still picture, and a two-dimensional Y/C separation process is performed on the motion picture, thereby the degree of noise reduction is switched depending on whether the image is a still picture or a motion picture. In the three-dimensional Y/C separation process using the correlation between frames, Y/C separation can be performed with higher precision, compared to the two-dimensional Y/C separation process using the correlation between lines; however, when the three-dimensional Y/C separation process is performed on a motion picture, the image is blurred due to the influence of the previous frame.

In Japanese Unexamined Patent Application Publication No. 2003-319203, only a binary determination of whether the image is a still picture or a motion picture is performed; therefore, for example, it is difficult to appropriately control the degree of noise reduction on an input image including a still picture and a motion picture.

In a related-art technique in which the binary determination of whether the input image is a still picture or a motion picture is performed so as to uniformly switch the degree of image correction, it is difficult to effectively perform image correction on an input image and obtain a high-quality image.

In view of the foregoing, it may be desirable to provide an image correction circuit capable of performing more effective image correction on an input image, and an image correction method and an image display.

According to an embodiment of the invention, there is provided an image correction circuit which may include a correction means for performing image correction on input image data; a detection means for detecting a degree of motion picture in the input image data; and a control means for controlling the degree of image correction by the correction means on the basis of the degree of motion picture detected by the detection means. In this case, “a degree of motion picture” may mean an index showing the degree of motion picture in input image data.

According to an embodiment of the invention, there is provided an image correction method which may include detecting a degree of motion picture in input image data; determining the degree of image correction on the input image data on the basis of the detected degree of motion picture; and performing image correction on the input image data according to the degree of image correction.

According to an embodiment of the invention, there is provided an image display which may include a correction means for performing image correction on input image data; a detection means for detecting a degree of motion picture in the input image data; a control means for controlling the degree of image correction by the correction means on the basis of the degree of motion picture detected by the detection means; and a display means for displaying an image on the basis of the input image data on which the image correction has been performed.

In the image correction circuit, the image correction method and the image display according to the embodiment of the invention, the degree of motion picture in the input image data may be detected, and the degree of image correction on the input image data may be controlled on the basis of the detected degree of motion picture.

The image correction circuit according to the embodiment of the invention may further include a separation means for performing signal separation of the input image data into a luminance signal and a chrominance signal; and a conversion means for performing IP conversion on the luminance signal and the chrominance signal, wherein the detection means detects at least one of a degree of motion picture during the signal separation and a degree of motion picture during the IP conversion, and the correction means performs image correction on the luminance signal on which the IP conversion has been performed. In such a configuration, the input image data may be separated into the luminance signal and the chrominance signal, and IP conversion may be performed on the luminance signal and the chrominance signal, and image correction may be performed on the luminance signal on which the IP conversion has been performed. Then, at least one of the degree of motion picture during signal separation and the degree of motion picture during IP conversion may be detected, and the degree of the above-described image correction may be controlled on the basis of the detected degree of motion picture. In addition, “IP conversion” may mean that an interlaced signal is converted into a noninterlaced signal (a progressive signal).

In this case, the image correction circuit may include a dividing means for dividing a unit frame of input image data into a plurality of data regions, wherein the separation means may include a two-dimensional Y/C separation means and a three-dimensional Y/C separation means both performing signal separation on each of the data regions, the detection means may include a first detection means for, during the signal separation, detecting the number of regions of motion picture among the plurality of data regions configuring each unit frame, and then outputting the number as a first degree of motion picture; a second detection means for, during the signal separation, detecting the number of data regions on which signal separation has been performed by the two-dimensional Y/C separation means among the plurality of data regions configuring each unit frame, and then outputting the number as a second degree of motion picture; and a third detection means for, during the IP conversion, detecting the number of regions of motion picture among the plurality of data regions configuring each frame, and then outputting the number as a third degree of motion picture, and the control means controls the degree of image correction on the basis of at least one of the first, second and third degrees of motion picture outputted.

In the image correction circuit, the image correction method and the image display according to the embodiment of the invention, the degree of motion picture in the input image data may be detected, and the degree of image correction on the input image data may be controlled on the basis of the detected degree of motion picture, so more effective image correction can be performed on an input image.

Other and further objects, features and advantages of the invention will appear more fully from the following description.

### BRIEF DESCRIPTION OF THE DRAWINGS

FIG. 1 is a circuit block diagram of the whole configuration of an image display according to an embodiment of the invention;

FIGS. 2A and 2B are plots for describing the basic operation of an enhancement circuit;

FIGS. 3A and 3B are plots for describing the basic operation of a sharpness circuit;

FIGS. 4A and 4B are schematic views for describing an example of a motion detection process by a motion detection circuit;

FIG. 5 is a flowchart for describing a determination operation by an X-output determining section;

FIGS. 6A and 6B are plots for describing the operation of an enhancement circuit in consideration of an X value; and

FIGS. 7A and 7B are plots for describing the operation of a sharpness circuit in consideration of an X value.

### DETAILED DESCRIPTION

A preferred embodiment will be described in detail below referring to the accompanying drawings.

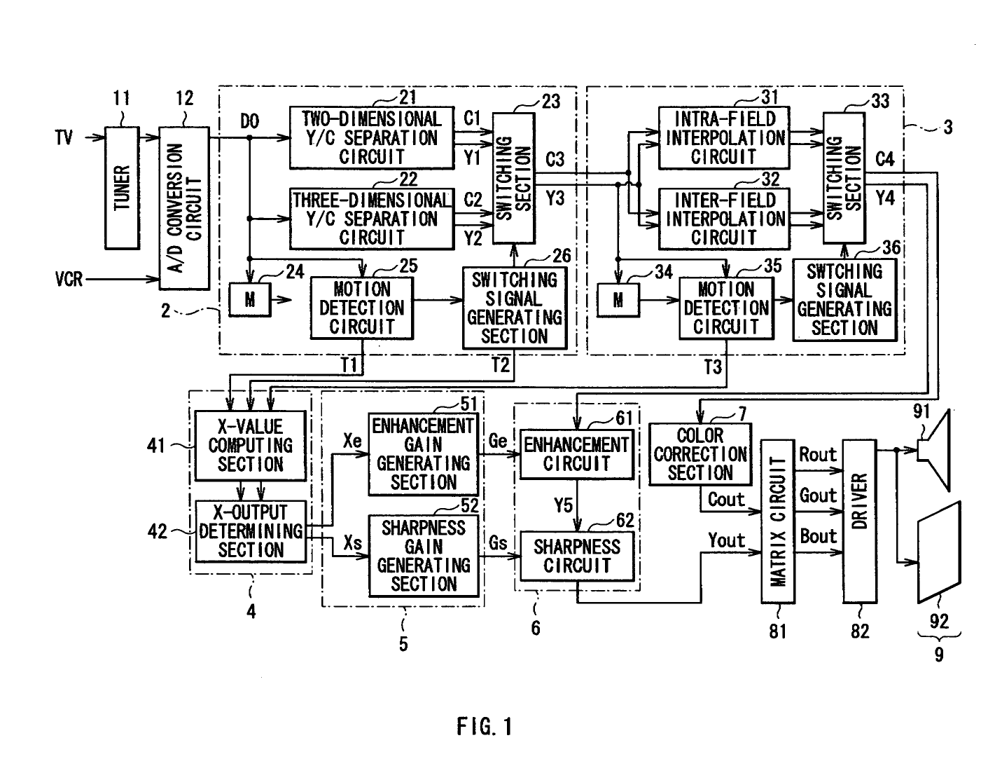

FIG. 1 shows the whole configuration of an image display according to an embodiment of the invention. The image display includes an image processing function section including a tuner 11, an A/D conversion circuit 12, a Y/C separation section 2, an IP conversion section 3, a control section 4, a gain generating section 5, a luminance correction section 6 and a color correction section 7, and an image display function section including a matrix circuit 81, a driver 82 and a display 9. An image correction circuit and an image correction method according to an embodiment of the invention are embodied by the image display according to the embodiment, so they will be also described below.

Image signals inputted into the image display may be outputs from a VCR (Video Cassette Recorder) or the like in addition to a TV signal from a TV. It has become common practice for recent televisions and personal computers (PCs) to obtain image information from a plurality of kinds of media and display an image corresponding to each of the media.

The tuner 11 receives and demodulates the TV signal from the TV, and outputs the TV signal as a composite video burst signal (CVBS).

The A/D conversion circuit 12 performs A/D (analog/digital) conversion of the composite video burst signal which is an analog signal inputted from the tuner 11 or the VCR into a digital signal, and outputs the digital signal to the Y/C separation section 2 as image data DO.

The Y/C separation section 2 performs a Y/C separation process in which the image data DO is separated into a luminance signal and a chrominance signal, and the signals are outputted. The Y/C separation section 2 includes a two-dimensional Y/C separation circuit 21, a three-dimensional Y/C separation circuit 22, a switching section 23, a frame memory 24, a motion detection circuit 25 and a switching signal generating section 26.

The two-dimensional Y/C separation circuit 21 performs a Y/C separation process using the correlation between lines, and separates the image data DO into a luminance signal Y1 and a chrominance signal Cl, and outputs them. On the other hand, the three-dimensional Y/C separation circuit 22 performs a Y/C separation process using the correlation between frames, and separates the image data DO into a luminance signal Y2 and a chrominance signal C2, and outputs them.

The frame memory 24 stores image data DO configuring 1 frame, and the frame memory 24 includes, for example, a DRAM (Dynamic Random Access Memory), a SRAM (Static Random Access Memory) or the like.

The motion detection circuit 25 detects a degree of motion picture T1 in Y/C separation on the basis of the image data D0 configuring 1 frame and the image data configuring the previous frame stored in the frame memory 24. More specifically, as will be described in detail later, image data configuring 1 frame inputted into the motion detection circuit 25 is divided into a plurality of data regions, and whether each data region is a still picture or a motion picture is determined, and the number of data regions which is determined as motion pictures in 1 frame is outputted to the control section 4 as the degree of motion picture T1.

The switching signal generating section 26 generates a switching signal for the switching section 23 on the basis of the determination result of whether each data region is a still picture or a motion picture by the motion detection circuit 25. Moreover, the switching section 23 selects either the luminance signal Y1 and the chrominance signal C1 from the two-dimensional Y/C separation circuit 21 or the luminance signal Y2 and the chrominance signal C2 from the three-dimensional Y/C separation circuit 22 according to the switching signal to output them as a luminance signal Y3 and a chrominance signal C3. Moreover, as will be described in detail later, the switching signal generating section 26 outputs the number of data regions selected to be outputted from the two-dimensional Y/C separation circuit 21 in 1 frame to the control section 4 as a degree of motion picture T2.

The IP conversion section 3 performs IP conversion in which the luminance signal Y3 and the chrominance signal C3 as interlaced signals are converted into noninterlaced signals (progressive signals) on the basis of a composite signal as an interlaced signal. The IP conversion section 3 includes an intra-field interpolation circuit 31, an inter-field interpolation circuit 32, a switching section 33, a frame memory 34, a motion detection circuit 35 and a switching signal generating section 36.

The intra-field interpolation circuit 31 performs IP conversion using date of 1 field by delaying each line of the inputted luminance signal Y3 and the inputted chrominance signal C3, and performing the interpolation of line data through the use of delayed line data or the like. On the other hand, the inter-field interpolation circuit 32 performs IP conversion using data of two fields by delaying each field of the inputted luminance signal Y3 and the inputted chrominance signal C3, and performing the interpolation of line data through the use of the delayed field data or the like.

The frame memory 34 stores data of luminance signals Y3 configuring 1 frame, and includes, for example, a DRAM, a SRAM or the like.

The motion detection circuit 35 basically plays the same role as the above-described motion detection circuit 25, and detects a degree of motion picture T3 during IP conversion on the basis of the data of luminance signal Y3 configuring 1 frame, data of the luminance signal Y3 configuring the previous frame stored in the frame memory 34. More specifically, the data of the luminance signal Y3 configuring 1 frame inputted into the motion detection circuit 35 is divided into a plurality of data regions, and whether each data region is a still picture or a motion picture is determined, and the number of data regions which is determined as motion pictures in 1 frame is outputted to the control section 4 as the degree of motion picture T3.

The switching signal generating section 36 generates a switching signal for the switching section 33 on the basis of a determination result of whether each data region is a still picture or a motion picture by the motion detection circuit 35. Moreover, the switching section 33 selects either a luminance signal or a chrominance signal from the intra-field interpolation circuit 31 or a luminance signal and a chrominance signal from the inter-field interpolation circuit 32 according to the switching signal, and outputs them as a luminance signal Y4 and a chrominance signal C4.

The control section 4 controls the gain generating section 5, and includes an X-value control section 41 and an X-output determining section 42.

The X-value computing section 41 determines an X value as a parameter corresponding to “susceptibility to blur” in image correction which will be described later and corresponding to a gain change amount in image correction in the luminance correction section 6 which will be described later by a predetermined arithmetic expression through the use of the degrees of motion picture T1, T2 and T3 outputted from the Y/C separation section 2 and the IP conversion section 3. Moreover, as will be described in detail later, the X-output determining section 42 determines whether the determined X value is outputted to the gain generating section 5, and in the case where it is determined that the X value is to be outputted, the X value (more specifically, an enhancement gain change amount Xe and a sharpness gain change amount Xs) is outputted to the gain generating section 5.

The gain generating section 5 generates a gain corresponding to the degree of image correction in the luminance correction section 6, and includes an enhancement gain generating section 51 and a sharpness gain generating section 52.

The enhancement gain generating section 51 generates an enhancement gain Ge as a gain in the enhancement circuit 61 in the luminance correction section 6 which will be described later, and in the case where the enhancement gain change amount Xe is outputted from the X-output determining section 42, the enhancement gain Ge is finally generated in consideration of the change amount Xe (more specifically by adding the change amount Xe). On the other hand, the sharpness gain generating section 52 generates a sharpness gain Gs as a gain in the sharpness circuit 61 in the luminance correction section 6 which will be described later, and in the case where the sharpness gain change amount Xs is outputted from the X-output determining section 42, the sharpness gain Gs is finally generated in consideration of the change amount Xs (more specifically by adding the change amount Xs).

The luminance correction section 6 performs a predetermined luminance correction process on the luminance signal Y4 of the luminance signal Y4 and the chrominance signal C4 outputted from the IP conversion section 3 after IP conversion, and in the image display according to the embodiment of the invention, the luminance correction section 6 includes an enhancement circuit 61 performing predetermined enhancement correction (an edge enhancement process) which will be described later and a sharpness circuit 62 performing predetermined sharpness correction (a resolution enhancement process) which will be described later.

The color correction section 7 performs a predetermined color correction process on the chrominance signal C4 of the luminance signal Y4 and the chrominance signal C4 outputted from the IP conversion section 3 after IP conversion, and includes, for example, a CTI (color transient improvement) circuit or the like. The CTI circuit is effective to improve the color transient of a chrominance signal, for example, in the case where the amplitude of the chrominance signal is large such as the case of an image of a color bar or the like.

The matrix circuit 81 reproduces RGB signals from a luminance signal Yout on which luminance correction has been performed by the luminance correction section 6 and a chrominance signal Cout on which color correction has been performed by the color correction section 7, and the reproduced RGB signals (Rout, Gout, Bout) are outputted to the driver 82.

The driver 82 generates a driving signal for the display 9 on the basis of the RGB signals (Rout, Gout, Bout) outputted from the matrix circuit 81, and outputs the driving signal to the display 9.

The display 9 displays an image on the basis of the YUV signals (Yout, Uout, Vout) after luminance correction and color correction according to the driving signal outputted from the driver 82. The display 9 may be any kind of display device. For example, a CRT (Cathode-Ray Tube) 91, an LCD (Liquid Crystal Display) 92, a PDP (Plasma Display Panel; not shown) or the like is used.

Next, the operation of the image display according to the embodiment will be described below referring to FIGS. 1 through 7A and 7B.

At first, the basic operation of the image display will be described below.

At first, an image signal inputted into the image display is converted into the image data D0 which is a digital signal. More specifically, a TV signal from the TV is demodulated into a composite video burst signal by the tuner 11, and a composite video burst signal is directly inputted into the image display from the VCR. The composite video burst signals which are analog signals are converted into digital signals by the D/A conversion circuit 12, thereby the digital signals become the image data D0.

Next, in the Y/C separation section 2, the image data D0 is separated into the luminance signal Y3 and the chrominance signal C3. More specifically, while the two-dimensional Y/C separation circuit 21 separates the inputted image data D0 into the luminance signal Y1 and the chrominance signal Cl, and outputs them, the three-dimensional Y/C separation circuit 22 separates the image data D0 into the luminance signal Y2 and the chrominance signal C2, and outputs them. Moreover, in the switching signal generating section 26, in the case where the motion detection circuit 25 determines that a data region is a still picture, as for the data region, a switching signal is generated and outputted to selectively output the luminance signal Y2 and the chrominance signal C2 from the three-dimensional Y/C separation circuit 22 by the switching section 23, and on the other hand, in the case where the motion detection circuit 25 determines that a data region is a motion picture, as for the data region, a switching signal is generated and outputted to selectively output the luminance signal Y1 and the chrominance signal C1 from the two-dimensional Y/C separation circuit 21 by the switching section 23. Thus, by the switching section 23, either the luminance signal Y1 or the luminance signal Y2 is selectively outputted as the luminance signal Y3, and either the chrominance signal C1 or the chrominance signal C2 is selectively outputted as the chrominance signal C3.

Next, the IP conversion section 3 performs IP conversion on the luminance signal Y3 and the chrominance signal C3. More specifically, the intra-field interpolation circuit 31 performs IP conversion using data of 1 field on the inputted luminance signal Y3 and the inputted chrominance signal C3, and the inter-field interpolation circuit 32 performs IP conversion using data of two fields on the inputted luminance signal Y3 and the inputted chrominance signal C3. Moreover, in the switching signal generating section 36, in the case where the motion detection circuit 35 determines that a data region is a still picture on the basis of the luminance signal Y3, as for the data region, the switching signal is generated and outputted, so the luminance signal and chrominance signal on which IP conversion has been performed by the inter-field interpolation circuit 32 are selectively outputted by the switching section 33. On the other hand, in the case where the motion detection circuit 25 determines that a data region is a motion picture, as for the data region, the switching signal is generated and outputted so that the luminance signal and the chrominance signal on which IP conversion has been performed by the intra-field interpolation circuit 31 are selectively outputted by the switching section 33. Thus, by the switching section 33, the luminance signal and the chrominance signal on which IP conversion has been performed by the inter-field interpolation circuit 32 or the intra-field interpolation circuit 31 are selectively outputted as the luminance signal Y4 and the chrominance signal C4, respectively.

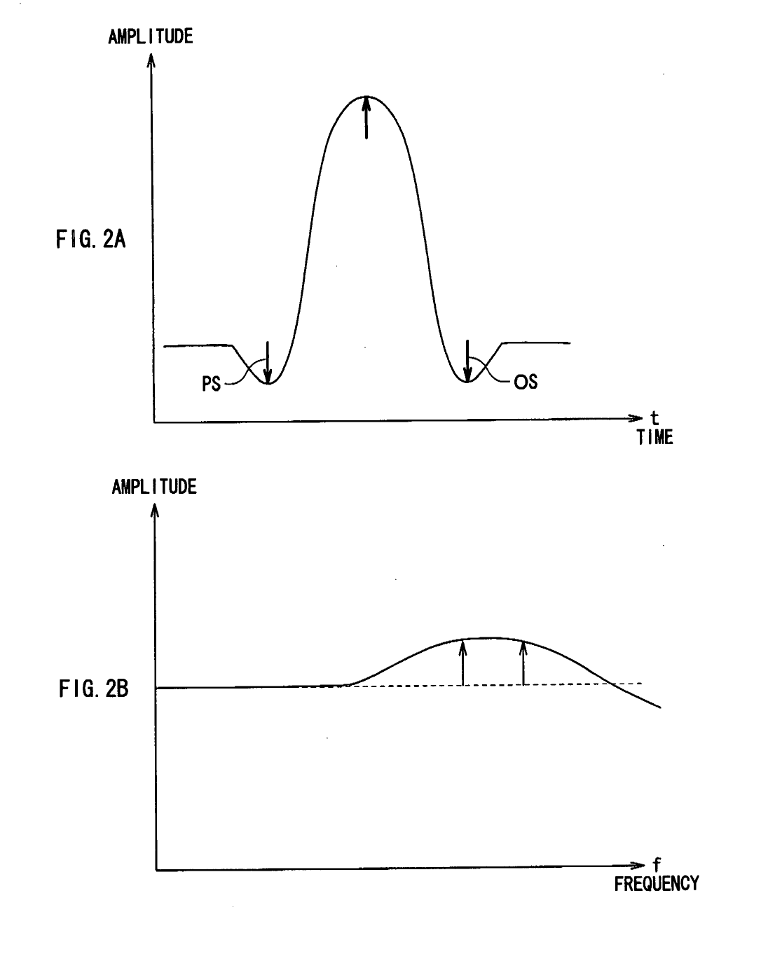

Next, in the luminance correction section 6, a predetermined luminance correction process is performed on the luminance signal Y4 on which IP conversion has been performed. More specifically, in the enhancement circuit 61, through the use of the enhancement gain Ge generated by the enhancement gain generating section 51 in the gain generating section 5, a signal waveform correction process, for example, as shown by arrows in FIG. 2A is performed on the luminance signal Y4. More specifically, a time change in a signal waveform is corrected so that the waveform includes a PS (preshoot) and an OS (overshoot) as shown in the drawing, thereby the edge of an image is enhanced. The frequency characteristics of the amplitude of a signal in the enhancement correction is as shown in FIG. 2B, and in particular, a correction process is performed so that the amplitude is increased on a high frequency side.

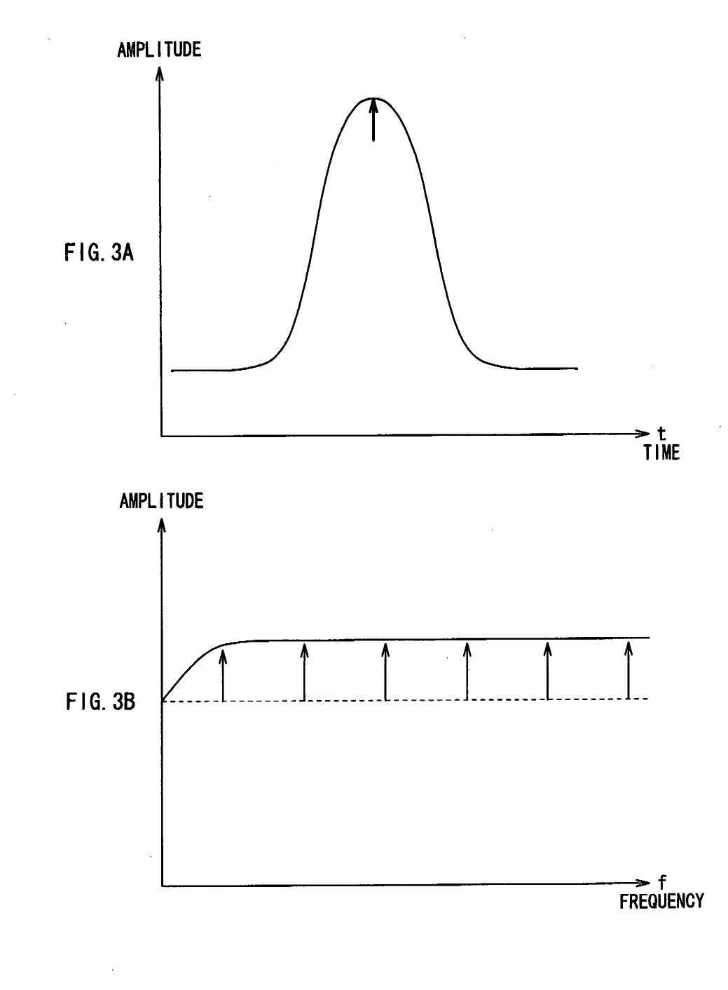

On the other hand, in the sharpness circuit 62, through the use of the sharpness gain Gs generated by the sharpness gain generating section 52 in the gain generating section 5, a signal waveform correction process as shown by arrows in FIG. 3A is performed on a luminance signal Y5 outputted from the enhancement circuit 61. More specifically, unlike the case of enhancement correction, a time change in a signal waveform is corrected so that the signal waveform does not include a PS and an OS, thereby the enhancement of the resolution is performed. The frequency characteristics of the amplitude of a signal in the sharpness correction is, for example, as shown in FIG. 3B, and unlike the case of the enhancement correction, the correction process is performed so that the amplitude is uniformly increased in almost the whole frequency range.

Moreover, in the color correction section 7, a predetermined color correction process is performed on the chrominance signal C4 on which IP conversion has been performed. More specifically, for example, in the case of the CTI circuit, in the case where the amplitude of the chrominance signal is large such as the case of an image of a color bar or the like, color correction is performed on the chrominance signal C4 so that the color transient is improved.

Next, the matrix circuit 81 reproduces the RGB signals (Rout, Gout, Bout) from the luminance signal (the output luminance signal Yout) on which luminance correction (enhancement correction and sharpness correction) has been performed by the luminance correction section 6 and the chrominance signal Cout on which color correction has been performed by the color correction section 7. The driver 82 generates the driving signal on the basis of the RGB signals (Rout, Gout, Bout), and an image is displayed on the display 9 on the basis of the driving signal. Thus, an image on which the image correction process has been performed is displayed on the display 9.

Next, the characteristic operation of the image display according to the embodiment will be described in detail below.

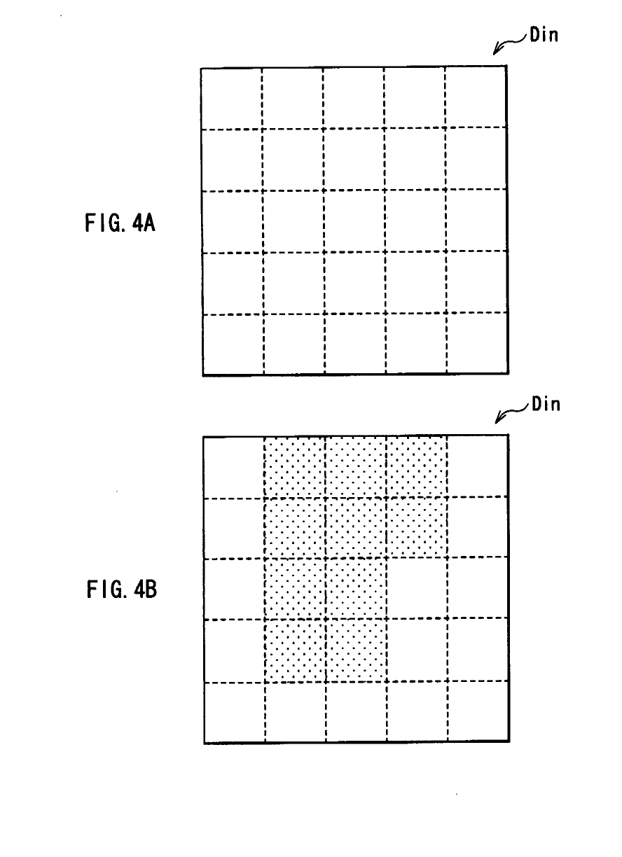

At first, the motion detection circuit 25 in the Y/C separation section 2 in the embodiment detects the degree of motion picture T1 in Y/C separation on the basis of the image data D0 configuring 1 frame, and the image data D0 configuring the previous frame stored in the frame memory 24. More specifically, as will be described in detail later, the image data configuring 1 frame inputted into the motion detection circuit 25 is divided into a plurality of data regions, and whether each data region is a still picture or a motion picture is determined, and the number of data regions which are determined as motion pictures in 1 frame is outputted to the control section 4 as the degree of motion picture T1. More specifically, for example, as shown in FIG. 4A, at first, image data Din configuring 1 frame inputted into the motion detection circuit 25 is divided into a plurality of data regions (in this case, 25 (5×5) data regions). Then, for example, as shown in FIG. 4B, whether each data region is a still picture or a motion picture is determined by taking a difference between the image data and the image data configuring the previous frame in each data region, and the number of data regions (hatched regions in FIG. 4B) which are determined as motion pictures is outputted to the control section 4 as the above-described degree of motion picture T1 (in this case, T1=10). In addition, data regions which are not hatched in FIG. 4B represent still pictures.

Moreover, as described above, the switching signal generating section 26 in the Y/C separation section 2 generates and outputs the switching signal for the switching section 23 on the basis of the determination result in the motion detection circuit 25, and at this time, the number of data regions actually selected to be outputted from the two-dimensional Y/C separation circuit 21 in 1 frame is outputted to the control section 4 as the degree of motion picture T2.

On the other hand, in the motion detection circuit 35 in the IP conversion section 3, as in the case of the motion detection circuit 25 in the above-described Y/C separation section 2, the degree of motion picture T3 during IP conversion is detected on the basis of the data of the luminance signal Y3 configuring 1 frame and the data of the luminance signal Y3 configuring the previous frame stored in the frame memory 34. More specifically, as shown in FIGS. 4A and 4B, the data of the luminance signal Y3 configuring 1 frame inputted into the motion detection circuit 35 is divided into a plurality of data regions, and whether each data region is a still picture or a motion picture is determined, and then the number of data regions which are determined as motion pictures in 1 frame is outputted to the control section 4 as the degree of motion picture T3.

Next, in the X-value computing section 41 in the control section 4, through the use of the degrees of motion picture T1, T2 and T3 outputted from the motion detection circuit 25 and the switching signal generating section 26 in the Y/C separation section 2 and the motion detection circuit 35 in the IP conversion section 3, by the following expressions (1) and (2), the enhancement gain change amount Xe as the change amount of the enhancement gain Ge and the sharpness gain change amount Xs as the change amount of the sharpness gain Gs are determined. In addition, K11 to K13 and K21 to K23 each represent a weighting coefficient of 0 or more.
Xe=(K11×T1)+(K12×T2)+(K13×T3) (1)
Xs=(K21×T1)+(K22×T2)+(K23×T3) (2)

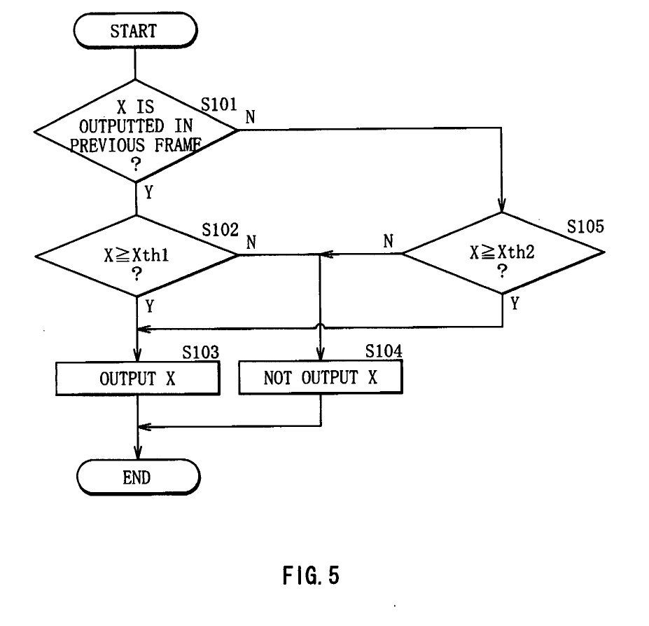

Next, in the X-output determining section 42 in the control section 4, for example, by steps in a flowchart shown in FIG. 5, a process of determining whether or not to output the X value (the enhancement gain change amount Xe and the sharpness gain change amount Xs) determined in the X-value computing section 41 is performed.

At first, the X-output determining section 42 determines whether the X value is outputted in the previous frame (step S101). In the case where it is determined that the X value is outputted in the previous frame (step S101: Y), the X-output determining section 42 determines whether each of the enhancement gain change amount Xe and the sharpness gain change amount Xs in the determined X value is equal to or larger than a predetermined threshold value Xth1 (step S102). The threshold value Xth1 may be individually designated for each of the enhancement gain change amount Xe and the sharpness gain change amount Xs. In the step S102, in the case where it is determined that the X value is equal to or larger than the threshold value Xth1 (step S102: Y), as “susceptibility to blur” in image correction is large, the X-output determining section 42 determines that it is necessary to generate a gain in consideration of the X value, and the X value is outputted to the gain generating section 5 (step S103), thereby the determination process is completed. Moreover, in the step S102, in the case where it is determined that the X value is smaller than the threshold value Xth1 (step S102: N), as “susceptibility to blur” in image correction is small, the X-output determining section 42 determines that it is not necessary to generate a gain in consideration of the X value, and does not output the X value to the gain generating section 5 (step S104), thereby the determination process is completed.

On the other hand, in the step S101, in the case where it is determined that the X value is not outputted in the previous frame (step S101: N), the X-output determining section 42 determines whether each of the enhancement gain change amount Xe and the sharpness gain change amount Xs in the determined X value is equal to or larger than a predetermined threshold value Xth2 (step S105). The threshold value Xth2 may be individually designated for each of the enhancement gain change amount Xe and the sharpness gain change amount Xs. Moreover, in this case, the X value is not outputted in the previous frame, so the threshold value Xth2 is designated to be smaller than the threshold value Xth1. Then, in the step S105, in the case where the X value is equal to or larger than the threshold value Xth2 (step S105: Y), the X-output determining section 42 outputs the X value to the gain generating section 5 (step S103), then the determination process is completed. Moreover, in the step S105, in the case where the X value is smaller than the threshold value Xth2 (step S105: N), the X-output determining section 42 does not output the X value to the gain generating section 5 (step S104), then the determination process is completed.

Next, in the enhancement gain generating section 51 and the sharpness gain generating section 52 in the gain generating section 5, as shown by the following expressions (3) and (4), in consideration of the enhancement gain change amount Xe and the sharpness gain change amount Xs outputted from the control section 4, the enhancement gain Ge and the sharpness gain Gs corresponding to the degree of correction in the luminance correction section 6 are generated. A gain Ge0 and a gain Gs0 represent initial gains generated in the gain generating section 5 without consideration of the enhancement gain change amount Xe and the sharpness gain change amount Xs. Thus, in the gain generating section 5, in the case where the X value is outputted from the control section 4, the enhancement gain Ge and sharpness gain Gs are generated and outputted so that the degree of correction in the luminance correction section 6 is increased.
Ge0+Xe=Ge (3)
Gs0+Xs=Gs (4)

Then, in the luminance correction section 6, a predetermined luminance correction process is performed in the following manner on the basis of the enhancement gain Ge and the sharpness gain Gs designated in consideration of the enhancement gain change amount Xe and the sharpness gain change amount Xs.

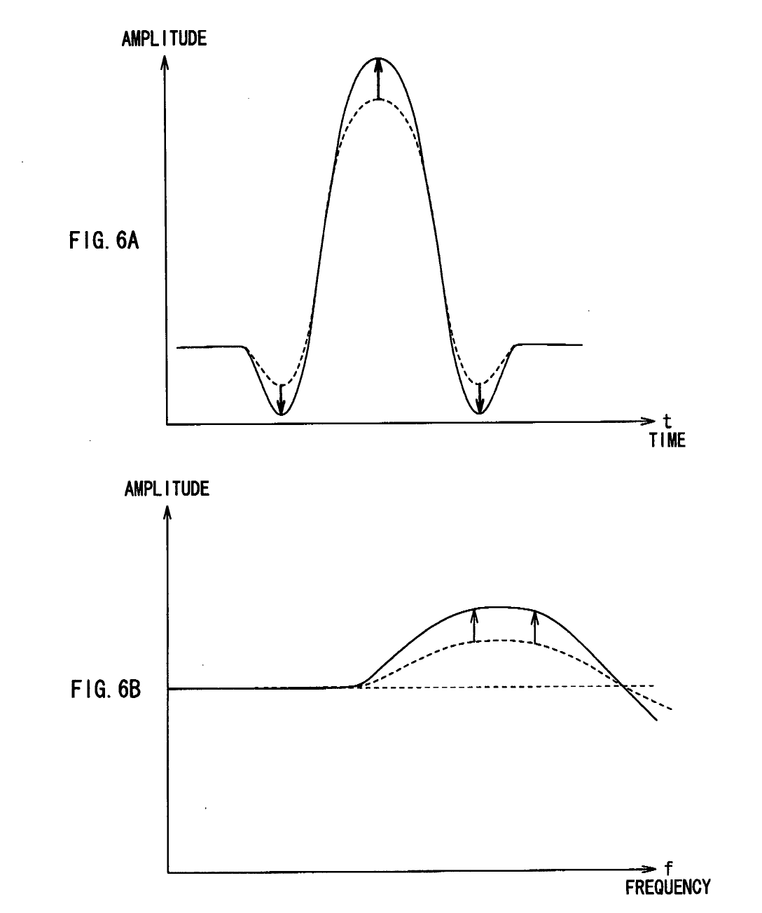

At first, in the enhancement circuit 61, in the case where the X value (the enhancement gain change amount Xe) is outputted from the control section 4, for example, as shown by solid lines and arrows in FIGS. 6A and 6B, the degree of the enhancement correction is increased according to the enhancement gain change amount Xe, thereby image correction for further enhancing edges is performed. In the case where the enhancement gain change amount Xe is not outputted from the control section 4, the enhancement gain Ge is equal to the initial gain Ge0 by the above-described expression (3), so as shown by dotted lines in FIGS. 6A and 6B, image correction without consideration of the enhancement gain change amount Xe is performed.

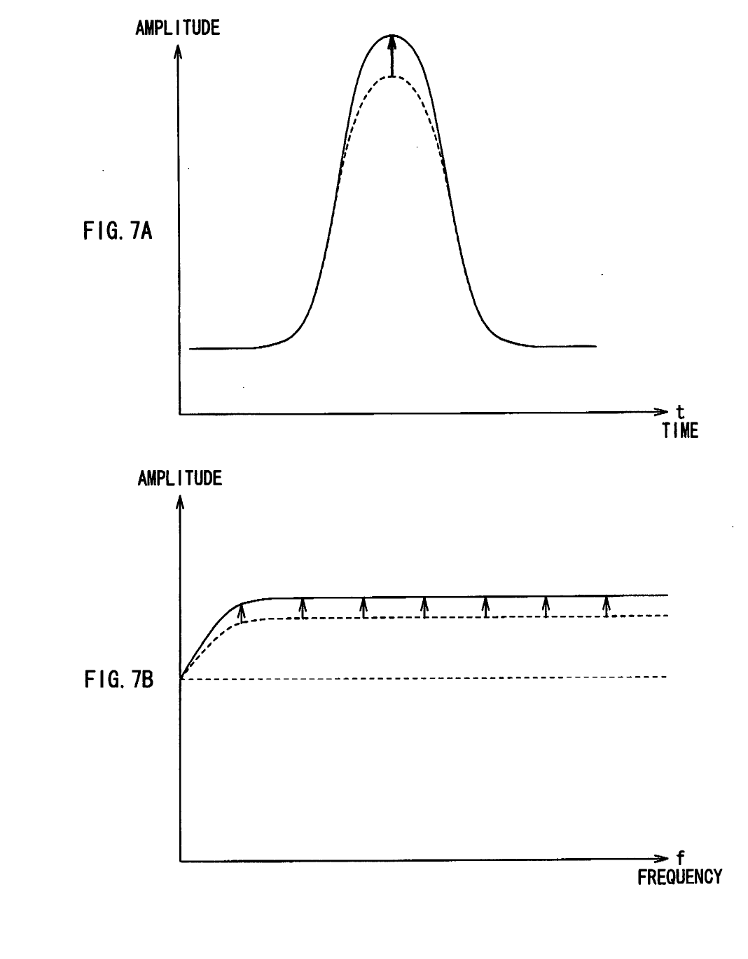

On the other hand, in the sharpness circuit 62, in the case where the X value (the sharpness gain change amount Xs) is outputted from the control section 4, as shown by solid lines and arrows in FIGS. 7A and 7B, the degree of sharpness correction is increased according to the sharpness gain change amount Xs, and image correction for further enhancing the resolution is performed. In the case where the sharpness gain change amount Xs is not outputted from the control section 4, the sharpness gain Gs is equal to the initial gain Gs0 by the above-described expression (4), so as shown by dotted lines in FIGS. 7A and 7B, image correction without consideration of the sharpness gain change amount Xs is performed.

Thus, in the image display according to the embodiment of the invention, the degrees of motion picture T1, T2 and T3 in Y/C separation and IP conversion are detected in each frame, and in consideration of the detected degree of motion pictures, the degree of luminance correction (the enhancement gain Ge and the sharpness gain Gs) is controlled, and a predetermined luminance correction process is performed on the basis of the designated enhancement gain Ge and the designated sharpness gain Gs, and an image is displayed on the basis of the luminance signal Yout after correction.

As described above, in the embodiment, the luminance correction section 6 performs image correction including enhancement correction and sharpness correction on the luminance signal Y4 on which Y/C separation by the Y/C separation section 2 and IP conversion by the IP conversion section 3 have been performed, and the degrees of motion picture T1, T2 and T3 in Y/C separation and IP conversion are detected in each frame, and in consideration of the detected degree of motion pictures, the degree of luminance correction (the enhancement gain Ge and the sharpness gain Gs) is controlled, so more effective image correction can be performed on an input image (image data D0) including a still picture and a motion picture in a unit frame.

Although the present invention is described referring to the embodiment, the invention is not limited to the embodiment, and can be variously modified.

For example, in the above-described embodiment, the case where the X value is determined by the expressions (1) and (2) in consideration of all of the degrees of motion picture T1, T2 and T3 is described; however, at least one of coefficients K11 to K13, or at least one of coefficients K21 to K23 may be designated to be larger than 0, and the X value may be determined in consideration of at least one of the degrees of motion picture T1, T2 and T3. Moreover, the values of the coefficients K11 to K13 and K21 to K23 can be freely designated, and according to the kind of the luminance correction process or the degree of correction, a computing method in which the degrees of motion picture T1, T2 and T3 are weighted (for example, in the case where the number T2 of the data regions selecting an output from the two-dimensional Y/C separation circuit is importantly controlled, the coefficients K12 and K22 are designated to be larger than the coefficients K11, K13, K21 and K23) may be used.

Moreover, in the above-described embodiment, the case where as a method of detecting the degree of motion picture during Y/C separation and IP conversion, image data is divided into a predetermined plurality of data regions, and the number of motion pictures included in 1 frame or the number of data regions selected to be outputted from the two-dimensional Y/C separation circuit is the degrees of motion picture T1, T2 or T3 is described; however, as a method of detecting the degree of motion picture during Y/C separation and IP conversion is not limited to the method of separating image data into a plurality of data regions, and any other detecting method may be used.

Further, in the above-described embodiment, the case where the threshold values Xth1 and Xth2 when determining whether the X value is outputted in the X-output determining section 42 are fixed values is described; however, the threshold value of the X value may be designated depending on the increasing process or the degreasing process of the X value, and a hysteresis change may be shown. In such a case, the degree of luminance correction (the enhancement gain Ge and the sharpness gain Gs) is prevented from being frequently changed in each frame when the X value is around the threshold value, and a situation in which the impression of an image greatly differs from frame to frame due to a little change in the X value can be prevented, so in addition to the effects in the above-described embodiment, a more natural image can be displayed.

Moreover, in the above-described embodiment, as the luminance correction process by the luminance correction section 6, the enhancement correction by the enhancement circuit 61 and the sharpness correction by the sharpness circuit 62 are described; however, at least one of the enhancement correction and the sharpness correction may be performed, or in addition to the above-described circuits, for example, a circuit performing contrast improvement or noise reduction may be included.

It should be understood by those skilled in the art that various modifications, combinations, sub-combinations and alterations may occur depending on design requirements and other factors insofar as they are within the scope of the appended claims or the equivalents thereof.

1. An image correction circuit comprising:
a correction means for performing image correction on input image data;
a detection means for detecting a degree of motion picture in the input image data; and
a control means for controlling the degree of image correction by the correction means on the basis of the degree of motion picture detected by the detection means.

2. The image correction circuit further comprising:
a separation means for performing signal separation of the input image data into a luminance signal and a chrominance signal; and
a conversion means for performing IP conversion on the luminance signal and the chrominance signal,
wherein the detection means detects at least one of a degree of motion picture during the signal separation and a degree of motion picture during the IP conversion, and
the correction means performs image correction on the luminance signal on which the IP conversion has been performed.

3. The image correction circuit according to claim 2, wherein the control means controls the degree of image correction on the basis of both of the degree of motion picture during the signal separation and the degree of motion picture during the IP conversion which are detected by the detection means.

4. The image correction circuit according to claim 2, wherein the correction means performs at least one of enhancement correction and sharpness correction on the luminance signal on which the IP conversion has been performed.

5. The image correction circuit according to claim 2 comprising:
a dividing means for dividing a unit frame of input image data into a plurality of data regions,
wherein the separation means includes a two-dimensional Y/C separation means and a three-dimensional Y/C separation means both performing signal separation on each of the data regions, the detection means includes:
a first detection means for, during the signal separation, detecting the number of regions of motion picture among the plurality of data regions configuring each unit frame, and then outputting the number as a first degree of motion picture;
a second detection means for, during the signal separation, detecting the number of data regions on which signal separation has been performed by the two-dimensional Y/C separation means among the plurality of data regions configuring each unit frame, and then outputting the number as a second degree of motion picture; and
a third detection means for, during the IP conversion, detecting the number of regions of motion picture among the plurality of data regions configuring each frame, and then outputting the number as a third degree of motion picture, and
the control means controls the degree of image correction on the basis of at least one of the first, second and third degrees of motion picture outputted.

6. The image correction circuit according to claim 5, wherein the control means determines the degree of image correction by the following expression:
X=(K1×T1)+(K2×T2)+(K3×T3)
where X represents the degree of image correction by the correction means, T1, T2 and T3 represent the first, second and third degrees of motion picture, respectively, and K1, K2 and K3 each represent a weighting coefficient equal to or larger than 0 (at least one of K1, K2 and K3 is larger than 0).

7. The image correction circuit according to claim 6, wherein the control means designates the coefficient K2 to be larger than the coefficient K1 and the coefficient K3.

8. The image correction circuit according to claim 1, wherein the control means changes the degree of image correction in the case where the detected degree of motion picture is larger than a predetermined threshold value.

9. An image correction method comprising:
detecting a degree of motion picture in input image data;
determining the degree of image correction on the input image data on the basis of the detected degree of motion picture; and
performing image correction on the input image data according to the degree of image correction.

10. An image display comprising:
a correction means for performing image correction on input image data;
a detection means for detecting a degree of motion picture in the input image data;
a control means for controlling the degree of image correction by the correction means on the basis of the degree of motion picture detected by the detection means; and
a display means for displaying an image on the basis of the input image data on which the image correction has been performed.

11. An image correction circuit comprising:
a correction section performing image correction on input image data;
a detection section detecting a degree of motion picture in the input image data; and
a control section controlling the degree of image correction by the correction section on the basis of the degree of motion picture detected by the detection section.

12. An image display comprising:
a correction section performing image correction on input image data;
a detection section detecting a degree of motion picture in the input image data;
a control section controlling the degree of image correction by the correction section on the basis of the degree of motion picture detected by the detection section; and
a display section displaying an image on the basis of the input image data on which the image correction has been performed.
